(19) United States
(12) Patent Application Publication
(10) Pub. No.: US 2012/0202113 A1
(43) Pub. Date: Aug. 9, 2012

(54) Lithium Ion Battery

(75) Inventors: James D. Hodge, Henderson, NV (US); Joseph C. Turner, Henderson, NV (US)

(73) Assignee: K2 ENERGY SOLUTIONS, INC., Henderson, NV (US)

(21) Appl. No.: 13/166,386

(22) Filed: Jun. 22, 2011

Related U.S. Application Data
(60) Provisional application No. 61/357,388, filed on Jun. 22, 2010.

(51) Int. Cl. H01M 4/64; H01M 4/136

(52) U.S. Cl. 429/211; 252/182.1

(57) ABSTRACT

A high rate lithium battery can include a cathode composition coated on a substrate. The cathode composition can include first and second active materials and binder. The first and second active materials can have different characteristics including, for example, particle size, tap density, and amount of conductive component. The first and second active materials can be combined to achieve higher packing densities of the active material, which may allow for a higher capacity battery as compared to conventional batteries formed with a single active material.

### CROSS-REFERENCE TO RELATED APPLICATION

The benefit of priority to U.S. Provisional Patent Application 61/357,388, filed on Jun. 22, 2010, is claimed and the priority document is incorporated herein by reference in its entirety.

### STATEMENT OF GOVERNMENT SUPPORT

This invention was made with government support under CERDEC W15P7T-09-C-S314 awarded by the U.S. Army. The government has certain rights in the invention.

### BACKGROUND OF THE INVENTION

1. Field of the Invention

The invention generally relates to a lithium ion battery having a high power density without a significant decrease in energy density and to methods of making the same, and more particularly to a cathode composition for the lithium ion battery and methods of making the same.

2. Background of the Invention

Lithium-ion batteries (sometimes referred to as Li-ion batteries) are a type of rechargeable battery in which lithium ions move between an anode and a cathode. The lithium ions move from the anode to the cathode while discharging and from the cathode to the anode while charging. Current collectors act to couple charge carriers between the anode and the cathode. Currently a focus of the investigation of lithium-ion batteries has been on using nano-sized lithium iron phosphate powders as the cathode active material. It has been asserted in the art that the nano-sized lithium iron phosphate powders (nano-particles) enable a higher rate of recharging of lithium iron phosphate batteries.

### SUMMARY OF THE DISCLOSURE

The cathodes of the present disclosure include at least first and second active materials having different particle sizes, which can achieve higher packing densities than conventional cathodes containing a single active material, such as conventional nano-sized lithium iron phosphate powders. As compared to a battery configured with cells having conventional cathodes formed with a single active material, a battery configured with cells having a cathode composition in accordance with an embodiment of the disclosure can exhibit a higher capacity and higher power over most of the discharge rate.

### BRIEF DESCRIPTION OF THE DRAWINGS

FIG. 1 is a schematic drawing of a cathode in accordance with an embodiment of the disclosure, illustrating the use of two cathode active materials;

FIG. 2 is a Ragone chart illustrating the energy density as a function of the power density for cells in accordance with embodiments of the disclosure;

FIG. 3 is a chart illustrating the voltage as a function of the amperage for cells in accordance with embodiments of the disclosure;

FIG. 4 is a multi-variant chart illustrating a comparison of the capacity of cells in accordance with embodiments of the disclosure;

FIG. 5 is a chart illustrating the capacity as a function of cathode composition coat weight for a power cell having a cathode in accordance with embodiments of the disclosures;

FIG. 6 is a chart illustrating the capacity as a function of cathode composition coat weight for a power cell having a cathode in accordance with embodiments of the disclosures;

FIG. 7 is a Ragone chart illustrating the energy density as a function of the power density for energy and power cells having cathodes in accordance with embodiments of the disclosures;

FIG. 8 is a discharge chart at 15 amp discharge, illustrating the discharge characteristics of a power cell having a cathode in accordance with embodiments of the disclosure;

FIG. 9 is a discharge chart illustrating the discharge characteristics at varying discharge amps of a cell having a cathode in accordance with embodiments of the disclosure;

FIG. 10 is a discharge chart illustrating the discharge characteristics at 40 A and 50 A of the cell of FIG. 8; and

FIG. 11 is a life cycle chart illustrating the capacity retention over charge/discharge cycles of a cell having a cathode in accordance with embodiments of the disclosure.

### DETAILED DESCRIPTION

While this invention is susceptible of embodiment in many different forms, there will be described herein in detail, a specific embodiment thereof with the understanding that the present disclosure is to be considered as an exemplification of the principles of the invention and is not intended to limit the invention to the specific embodiment illustrated.

A battery typically includes a plurality of battery cells. Through control of cell design, a battery having a high power density without a substantial decrease in energy density can be formed using a cathode composition having first and second active materials. As compared to conventional cells formed with a single active material, such as nano-sized lithium iron phosphate powders, the cells of the present disclosure can result in a battery having a higher capacity over most of the discharge area.

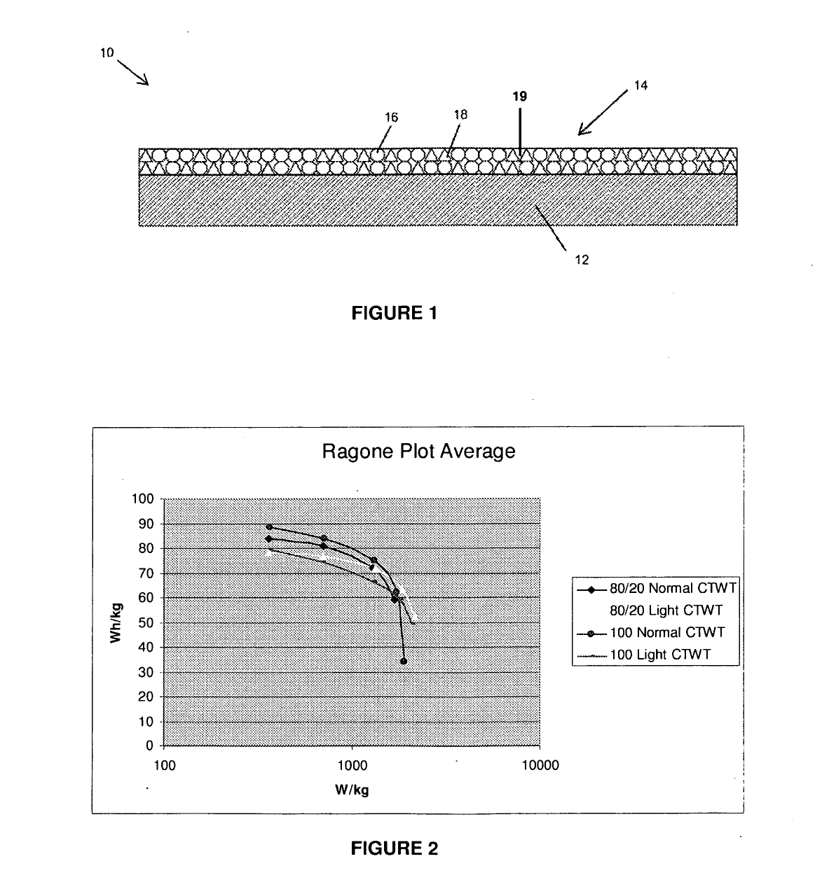

Referring to FIG. 1, the battery cell includes a cathode 10 containing a cathode composition 14 coated on a substrate 12. The cathode composition 14 may include at least a first lithium ion active material 16 and a second lithium ion active material 18 mixed with a binder 19. The first and second active materials 16, 18 may be different. For example, the first and second active materials may have different compositions, particle sizes, tap densities, and/or amount of conductive carbon.

The cathode 10 may be used in connection with an anode to form the electrodes of a lithium ion battery cell, for example, a cylindrical lithium ion battery cell. Lithium ion battery cells can be assembled as a battery as is known in the art. For example, the cathode 10 can be used in a rechargeable lithium-ion 18650 or 26650 battery. The anode can include known anode active materials for use in lithium ion batteries. For example, the anode active material can be carbon based, such as graphite, or a lithium metal.

As known in the art, the substrate 12 may be a metal foil, such as aluminum.

The active materials 16, 18 may be a composition containing predominately lithium iron phosphate, lithium manganese phosphate, lithium cobalt oxide, lithium nickel oxide or other suitable lithium containing materials. The first and second active materials may have the same composition or may have different compositions. The active materials 16, 18 may further include a conductive component, such as conductive carbon.

The active materials may have an average particle size of about 100 nm to about 20 μm, about 300 nm to about 10 μm, about 500 nm to about 5 μm, or about 800 nm to about 1 μm. Other suitable average particle sizes include about 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1 μm, 2, μm, 3 μm, 4 μm, 5 μm, 6 μm, 7 μm, 8 μm, 9 μm, 10 μm, 11 μm, 12 μm, 13 μm, 14 μm, or 15 μm. In some embodiments, the first active material 16 can have an average particle size larger than the average particle size of the second active material 18. Use of a mixture of active materials having different average particle sizes may allow for increased packing density of the active material particles.

The active materials may have a tap density of about 0.1 g/cm³ to about 5 g/cm³, about 0.2 g/cm³ to about 3 g/cm³, about 0.4 g/cm³ to about 1 g/cm³, or about 0.6 g/cm³ to about 0.8 g/cm³. Other suitable tap densities include about 0.1, 0.2, 0.3, 0.4, 0.5, 0.6, 0.7, 0.8, 0.9, 1, 1.5 2, 2.5, 3, 3.5, 4, 4.5, or 5 g/cm³. The tap density, or maximum packing density of the powder, can be determined by, for example, dropping a measuring cylinder containing the powder sample from a height of 3 mm at a rate of approximately 250 drops per minute. Preferably, the tap density measurement complies with one or more of the following standardized tests: USP 616, ASTM B 527, DIN EN ISO 787-11 and EP 2.9.34.

In one embodiment, the first active material 16 includes a greater amount of conductive carbon as compared to the second active material 18 and is designed as a power active material, while the second active material 18 is designed as an energy active material. A suitable first active material 16 can include about 4.3 wt. % lithium, about 34.8 wt. % iron, about 19.3 wt. % phosphate, and about 1.3 wt. % carbon. The first active material 16 can have a particle size distribution (d₁₀) of less than 1.5 μm, a particle size distribution (d₅₀) of less than 3.5 μm, a particle size distribution (d₉₀) of less than 6 μm, and a particle size distribution (d_{99.9}) of less than 15 microns. A suitable second active material 18 can include about 4.55 wt. % lithium, about 32.9 wt. % iron, about 19.1 wt. % phosphate, and about 2.25 wt. % carbon. The second active material 16 can have a particle size distribution (d₁₀) of less than 0.3 μm, a particle size distribution (d₅₀) of less than 0.7 μm, a particle size distribution (d₉₀) of less than 5 μm, The first and second active materials can be mixed in a ratio of about 1:1 to about 1:9. Other suitable ratios include 1:1, 1:2, 1:3, 1:4, 1:5, 1:6, 1:7, 1:8, or 1:9.

The active materials may be combined with a binder. The binder can assist in binding and retaining the active materials on the substrate 12. Suitable binders include, for example, polyvinylidene fluoride (PVDF). The binder may be included in an amount in a range of about 1 to 10 wt. % based on the total weight of the cathode composition 14. The amount of binder, however, may depend upon the type of battery cell, for example, a power cell or an energy cell. In a power cell, the amount of binder in the cathode composition 14 may be increased as compared to an energy cell. For a power cell, for example, the binder may be included in a range of about 5 to 10 wt. %. For an energy cell, for example, the binder may be included in a range of about 1 to 5 wt. %.

The cathode composition 14 is coated on at least one side of the substrate 12. However, the cathode composition 14 can be coated on opposing sides of the substrate 12. The cathode composition 14 can also be coated so as to cover the entire surface of the substrate 12. The cathode composition 14 may be coated on the substrate 12 at a coat weight per side of the substrate 12 of about 50 g/cm² to about 150 g/cm², about 75 g/cm² to about 125 g/cm², about 90 g/cm² to about 115 g/cm². Other suitable coat weights include about 50, 55, 60, 65, 70, 75, 80, 85, 90, 95, 100, 105, 110, 115, 120, 125, 130, 135, 140, 145, or 150 g/cm². The coat weight may be used to tailor characteristics of the cathode 10. For example, a battery configured with cells having cathodes with thinner coat weights have lower impedance and higher power density, while a battery configured with cells having cathodes with thicker coat weights have higher impedance and higher energy densities. As compared to cathodes of conventional lithium ion batteries formed with nano-lithium iron phosphate powder, the cathode 10 in accordance with embodiments of the present disclosure may be formed with lower coat weights without resulting in a corresponding decrease in battery capacity, which is expected to occur with decreasing coat weights. Without intending to be bound by theory, it is believed that with conventional active materials, a thinner coat weight allows for transfer of ions to occur more quickly, which results in a corresponding increase in the discharge rate and a decrease in the capacity. The cathode composition 14 of the present disclosure demonstrates a substantially similar or higher capacity at lower coat weights, as compared to a conventional cathode composition. Without intending to be bound by theory, it is further believed that increased packing density achieved with the cathode composition 14 allows for the maintenance or increase in capacity at a lower coat weight.

The cathode composition 14 may be designed, for example, for use in a power cell or an energy cell. A battery configured with power cells can have a capacity at 25.6 V of about 3.6 Ah, while a battery configured with energy cells will have a capacity at 25.6 V of about 4.35 Ah. The battery configured with power cells may have a continuous discharge of about 35 A, a maximum 60 second pulse discharge of about 70 A, and a maximum 10 second pulse discharge of about 110 A. The battery configured with energy cells may have a continuous discharge of about 20 A, a maximum 60 second pulse discharge of about 40 A, and a maximum 10 second pulse discharge of about 60 A.

In another embodiment, the lithium ion battery includes a plurality of current collectors; an anode active material in contact with at least one of the current collectors; and a cathode active material that comprises a first plurality of lithium iron phosphate particles having a first average particle size and a second plurality of lithium iron phosphate particles having a second average particle size; the cathode active material in contact with at least one of the current collectors; the cathode active material having a bimodal distribution of lithium iron phosphate particles. In embodiments of this battery, the first average particle size can be about 3.5 μm, and/or the second average particle size can be about 0.7 mm. In additional embodiments of this battery, the first plurality of lithium iron phosphate particles can be included in the cathode material in a weight percentage in a range of 5 wt. % to 60 wt. %, 10 wt. % to 45 wt. %, or 15 wt. % to 25 wt. % as a function of the total weight of lithium iron phosphate particles. The first plurality of lithium iron phosphate particles can be included in cathode material as 20 wt. % of the total weight of lithium iron phosphate particles. In another embodiment, the cathode active material can include about 1 to 10 wt. % of a binder based on the total weight of the cathode active material.

In yet another embodiment, the cathode active material have a tap density greater than either a tap density of the first plurality of lithium iron phosphate particles or a tap density of the second plurality of lithium iron phosphate particles. Furthermore, the cathode active material has a tap density that is greater than both the tap density of the first plurality of lithium iron phosphate particles and the tap density of the second plurality of lithium iron phosphate particles.

In still another embodiment, the resistance of a cathode active material that includes a plurality of lithium iron phosphate particles can be reduced by a method that includes providing a plurality of lithium iron phosphate particles having a first resistance; and admixing with the plurality of lithium iron phosphate particles having the first resistance a plurality of lithium iron phosphate particles having a second resistance that is greater than the first resistance, to form an admixture; wherein the resistance of the admixture is equal to or less than the first resistance. The plurality of lithium iron phosphate particles having the first resistance can have an average particle size of about 0.7 μm; and the plurality of lithium iron phosphate particles having the second resistance can have an average particle size of about 3.5 μm.

The admixing can include providing in the admixture a range of 5 wt. % to 60 wt. %, a range of 10 wt. % to 45 wt. %, a range of 15 wt. % to 25 wt. %, or 20 wt. % of the lithium iron phosphate particles having the second resistance, as a function of the total weight of lithium iron phosphate particles.

### EXAMPLES

The following examples are provided for illustration and are not intended to limit the scope of the invention.

### Examples 1-4

### Cathode Compositions

Cathodes were made using a cathode composition 14 having the composition shown in Table 1.

TABLE 1
Cathode Compositions and Coat Weights

| | First Active | Second Active | |
|---|---|---|---|
| | Material | Material | Coat Weight |
| Example 1 | 20% | 80% | 115 g/m² per side |
| Example 2 | 20% | 80% | 90 g/m² per side |
| Example 3 | 0% | 100% | 115 g/m² per side |
| Example 4 | 0% | 100% | 90 g/m² per side |

The first active material has an average particle size of about 3.5 μm and a tap density of about 1.0 g/cm³. The second active material has an average particle size of about 0.7 μm and a tap density of about 0.6 g/cm³. The composition of the first and second active materials is described in table 2, below. The physical characteristics of the first and second active materials are described in table 3, below.

TABLE 2
Compositions of the First and Second Active Materials

| | First Active | Second Active |
|---|---|---|
| Element | Material | Material |
| Lithium | 4.3 wt. % | 4.55 wt. % |
| Iron | 34.8 wt. % | 32.9 wt. % |
| Phosphate | 19.3 wt. % | 19.1 wt. % |
| Carbon | 1.3 wt. % | 2.25 wt. % |

TABLE 3
Physical Characteristics of the First and Second Active Materials

| | First Active | | Second Active | |
|---|---|---|---|---|
| | Material | | Material | |
| Particle size distribution (d₁₀) | ≦1.5 | μm | ≦0.3 | μm |
| Particle size distribution (d₅₀) | ≦3.5 | μm | ≦0.7 | μm |
| Particle size distribution (d₉₀) | ≦6.0 | μm | ≦5.00 | μm |
| Particle size distribution (d_{99.9}) | ≦15.0 | μm | Not available | |
| Tap Density | 1.0 ± 0.2 | g/cm³ | 0.6 ± 0.1 | g/cm³ |
| Specific Surface Area | 12.5 ± 2.5 | m²/g | 14.0 ± 3.0 | m²/g |

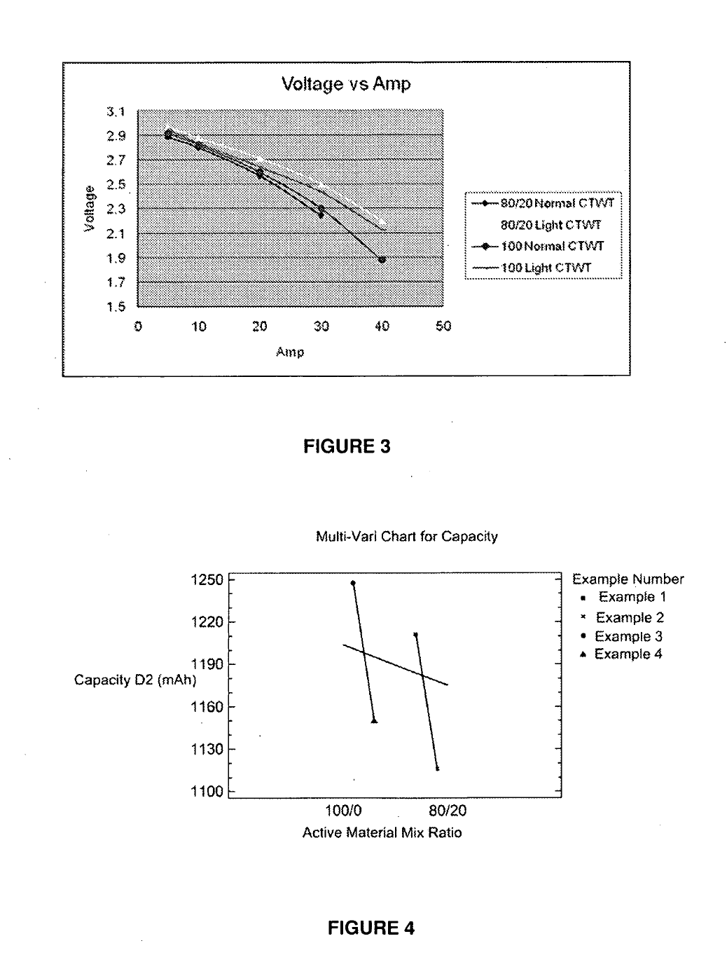

Referring to Table 4 and FIGS. 2 and 3, the conditioning data of the cells was tested. The addition of the first active material to the mix reduces both the capacity and the impedance. Reducing the coat weight also reduces both the capacity and the impedance. The batteries configured with cells having lower coat weight, lower impedance cathodes have higher power density while the batteries configured with cells having higher coat weight, higher impedance cathodes have a higher energy density. As illustrated in FIGS. 2 and 3, cells having cathode compositions containing a combination of the first and second active materials demonstrate a higher power density at higher energy densities as compared to cells having cathode compositions containing only the second active material. In particular, a cell having a cathode composition 14 including a mixture of the first and second active materials, which is coated on the substrate 12 at a coat weight of about 90 g/cm2 per side (i.e., light coat weight) demonstrated the best balance of high energy density and high power density.

TABLE 4
Conditioning Data

| | Capacity D2 | Open Circuit | Impedance |
|---|---|---|---|
| | (mAh) | Voltage (V) | (mΩ) |
| Example 1 | 1211.0 | 3.2999 | 23.24 |
| Example 2 | 1115.8 | 3.2998 | 15.53 |
| Example 3 | 1247.3 | 3.2993 | 24.41 |
| Example 4 | 1150.8 | 3.2992 | 19.91 |

Through manipulation of the coat weight and active material content of the cells, a custom cell having a certain power or energy density may be created. Referring to FIG. 4, for example, using all second active material at a light coat weight gives the highest available power density and, at the higher coat weights, the highest energy density.

### Examples 5-16

### Effect of Coat Weight on Capacity and Impedance in a Power Cell

Power cells in accordance with an embodiment of the disclosure can be used in an 18650 power cell. The cells can be constructed in accordance with the dimensions set forth in Table 5. The cathode composition 14 can include a mixture of active materials—the first and second active materials of Example 1—in a ratio of about 1 to about 4. The projected capacity and impedance of the cells as calculated form the cell characteristics are shown in Table 5.

TABLE 5

| | Example | Example | Example | Example | Example | Example |
|---|---|---|---|---|---|---|
| | 5 | 6 | 7 | 8 | 9 | 10 |
| Cathode Coat Weight | 115 | 90 | 80 | 70 | 60 | 50 |
| (g/cm2 per side) | | | | | | |
| Anode Coat Weight | 52.2 | 40.9 | 36.3 | 31.8 | 27.3 | 22.7 |
| (g/cm2 per side) | | | | | | |
| Separator Thickness(cm) | 0.020 | 0.02 | 0.02 | 0.02 | 0.02 | 0.02 |
| Thickness (cm) | 0.222 | 0.184 | 0.169 | 0.154 | 0.139 | 0.124 |
| Length (cm) | 796 | 950 | 1040 | 1140 | 1260 | 1420 |
| Width (cm) | 55 | 55 | 55 | 55 | 55 | 55 |
| Grams Cathode film (g) | 10.0 | 9.3 | 9.1 | 8.7 | 8.2 | 7.7 |
| Projected capacity (mAh)PO | 1239.1 | 1156.9 | 1125.5 | 1079.2 | 1021.9 | 959.1 |
| Projected Impedance (mΩ) | 15.0 | 12.6 | 11.5 | 10.5 | 9.5 | 8.4 |
| | Example | Example | Example | Example | Example | Example |
| | 11 | 12 | 13 | 14 | 15 | 16 |
| Cathode Coat Weight | 40 | 30 | 20 | 15 | 10 | 5 |
| (g/cm2 per side) | | | | | | |
| Anode Coat Weight | 18.2 | 13.6 | 9.1 | 6.8 | 4.5 | 2.3 |
| (g/cm2 per side) | | | | | | |
| Separator Thickness(cm) | 0.02 | 0.02 | 0.02 | 0.02 | 0.02 | 0.02 |
| Thickness (cm) | 0.109 | 0.094 | 0.079 | 0.072 | 0.064 | 0.057 |
| Length (cm) | 1610 | 1870 | 2230 | 2460 | 2750 | 3120 |
| Width (cm) | 55 | 55 | 55 | 55 | 55 | 55 |
| Grams Cathode film (g) | 7.0 | 6.1 | 4.8 | 4.0 | 3.0 | 1.6 |
| Projected capacity (mAh)PO | 869.1 | 755.9 | 599.0 | 494.0 | 365.8 | 203.5 |
| Projected Impedance (mΩ) | 7.4 | 6.4 | 5.4 | 4.9 | 4.3 | 3.8 |

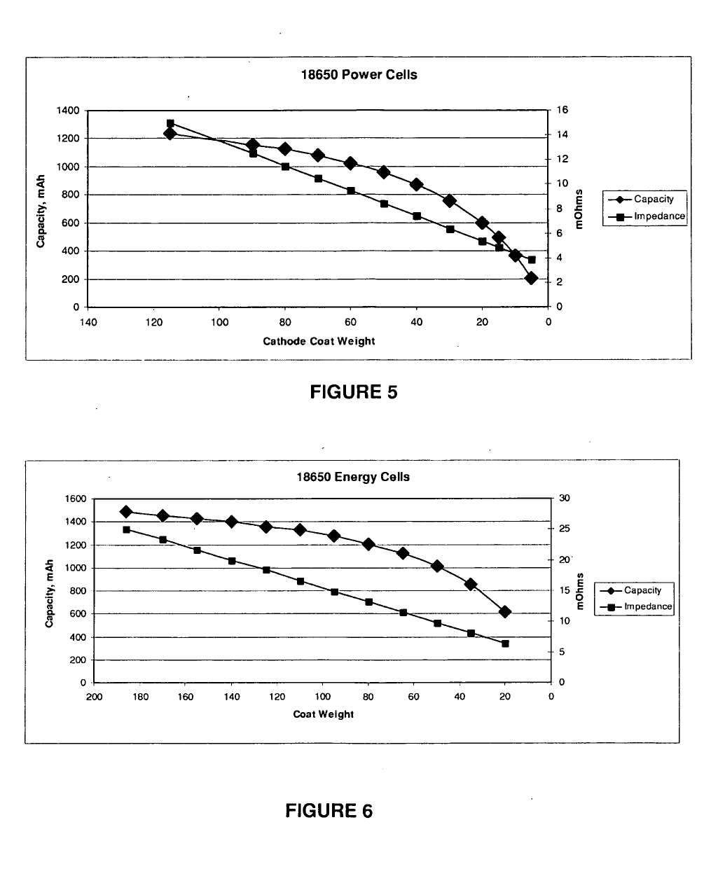

Referring to FIG. 5, examples 5-16 demonstrate that as the coat weight is decreased, the capacity and impedance correspondingly decrease.

### Examples 17-28

### Effect of Coat Weight on an Energy Cell

Energy cells in accordance with an embodiment of the disclosure can be used in an 18650 energy cell. The cells can be constructed in accordance with the dimensions set forth in Table 6. The cathode composition 14 can include a mixture of active materials—the first and second active materials of Example 1—in a ratio of about 1 to 4. The projected capacitance and impedance of the cells as calculated from the cell characteristics are shown in Table 6.

TABLE 6

| | Example | Example | Example | Example | Example | Example |
|---|---|---|---|---|---|---|
| | 17 | 18 | 19 | 20 | 21 | 22 |
| Cathode Coat Weight | 186 | 170 | 155 | 140 | 125 | 110 |
| (g/cm2 per side) | | | | | | |
| Anode Coat Weight | 86.162 | 78.750 | 71.801 | 64.853 | 57.904 | 50.956 |
| (g/cm2 per side) | | | | | | |
| Separator Thickness(cm) | 0.025 | 0.025 | 0.025 | 0.025 | 0.025 | 0.025 |
| Thickness (cm) | 0.321 | 0.298 | 0.277 | 0.255 | 0.234 | 0.212 |
| Length (cm) | 590 | 630 | 680 | 740 | 800 | 890 |
| Width (cm) | 55 | 55 | 55 | 55 | 55 | 55 |
| Grams Cathode film (g) | 12.0 | 11.7 | 11.5 | 11.3 | 10.9 | 10.7 |
| Projected capacity (mAh)PO | 1487.6 | 1451.5 | 1428.4 | 1403.8 | 1354.7 | 1326.1 |
| Projected Impedance (mΩ) | 25.0 | 23.4 | 21.7 | 19.9 | 18.4 | 16.6 |
| | Example | Example | Example | Example | Example | Example |
| | 23 | 24 | 25 | 26 | 27 | 28 |
| Cathode Coat Weight | 95 | 80 | 65 | 50 | 35 | 20 |
| (g/cm2 per side) | | | | | | |
| Anode Coat Weight | 44.007 | 37.059 | 30.110 | 23.162 | 16.213 | 9.265 |
| (g/cm2 per side) | | | | | | |
| Separator Thickness(cm) | 0.025 | 0.025 | 0.025 | 0.025 | 0.025 | 0.025 |
| Thickness (cm) | 0.191 | 0.169 | 0.147 | 0.126 | 0.104 | 0.083 |
| Length (cm) | 990 | 1110 | 1280 | 1500 | 1810 | 2280 |
| Width (cm) | 55 | 55 | 55 | 55 | 55 | 55 |
| Grams Cathode film (g) | 10.3 | 9.7 | 9.1 | 8.2 | 6.9 | 4.9 |
| Projected capacity (mAh) | 1273.5 | 1201.9 | 1125.5 | 1013.7 | 854.8 | 612.7 |
| Projected Impedance (mΩ) | 14.9 | 13.3 | 11.5 | 9.8 | 8.1 | 6.5 |

Referring to FIG. 6, examples 17-28 demonstrate that as the coat weight is decreased, the capacity and impedance correspondingly decrease.

### Example 29

### Comparison of a Cell Having a Cathode Composition 14 in Accordance with an Embodiment of the Disclosure and a Conventional Nano-LFP Cell

A cathode composition 14 in accordance with an embodiment of the present disclosure was used to form an 18650 power cell and an 18650 energy cell. The cathode composition 14 of the power cell and the energy cell included a mixture of the first and second active materials of Example 1 in a ratio of about 1 to about 4.

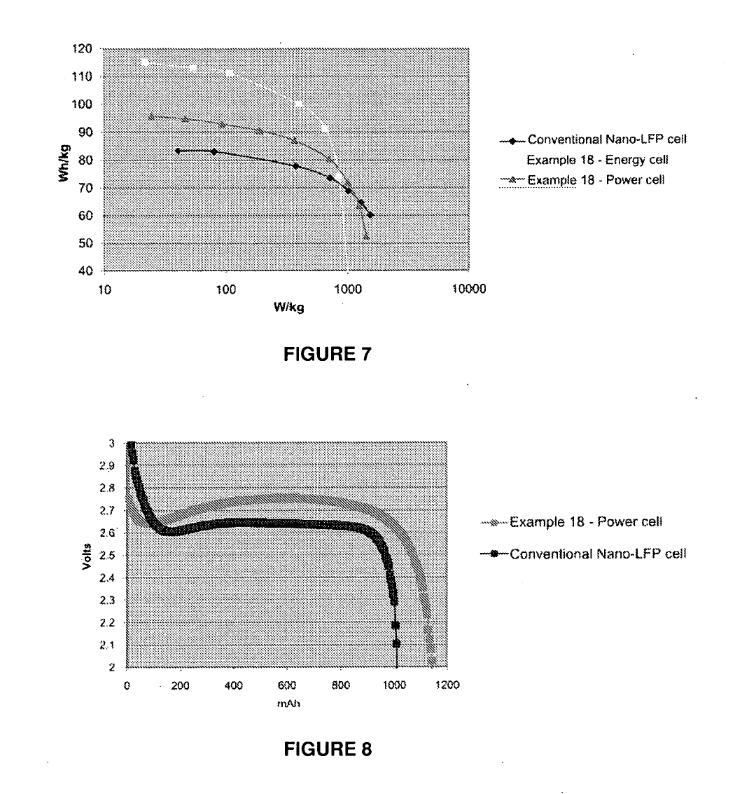

The capacity over a discharge rate range of batteries configured with cells having the cathodes of the present example were compared to the capacity of a battery configured with cells having a conventional cathode formed from a single active material, which was nano-sized lithium iron phosphate. As shown in FIG. 7, the battery configured with the cells of the present example demonstrates a higher capacity than the conventional battery cell over most of the discharge rate range tested. FIG. 8 further illustrate the higher capacity demonstrated by the battery configured with the cells of the present example at a 15 Amp discharge. FIG. 8 further illustrates the high power exhibited by the battery configured with the cells of the present example over most of the discharge curve. The discharge curves also demonstrate that the battery configured with the cells of the present example demonstrated stable voltage over the bulk of the discharge curve.

### Example 30

### Discharge Characteristics of a 26650 Cell Haying a Cathode Composition 14 in Accordance with the Disclosure

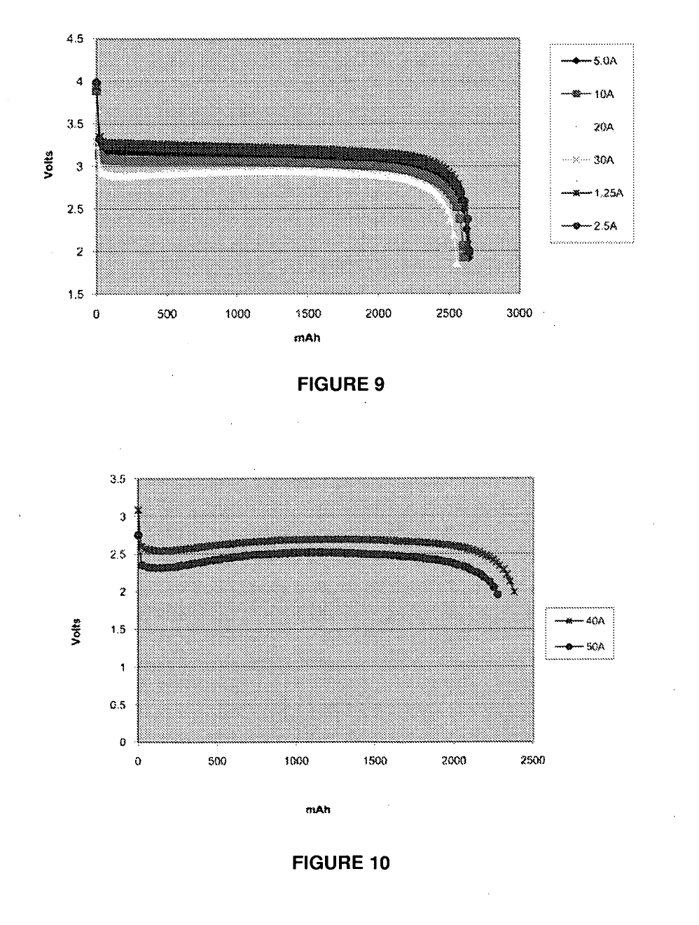

The cathode composition 14 of the power cell of Example 29 was incorporated into cells of a 26650 battery and its discharge characteristics were tested over a range of currents from about 1.25 amps to about 50 amps. Referring to FIGS. 9 and 10, the discharge curves demonstrate that the battery configured with cells in accordance with the disclosure demonstrates stable voltage over the bulk of the discharge curve.

### Example 31

### Capacity Retention on Life Cycling

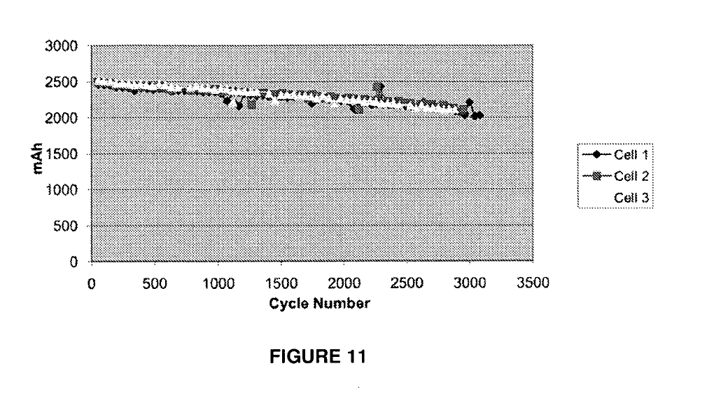

The 26650 battery configured with cells in accordance with the cells of Example 30 were tested to determine the capacity retention on life cycling. The battery retained greater than 80% of the initial capacity over more than 1000 full discharge cycles. FIG. 11 illustrates capacity retention of three batteries configured with cells in accordance with example 30 over 3000 cycles. The batteries were charged and discharged at about 7.8 amps between 20% and 80% state-of-charge. The total capacity was checked every 50 cycles by discharging at about 1.3 amps.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims

1. A lithium ion battery comprising:
a plurality of current collectors;
an anode active material in contact with at least one of the current collectors; and
a cathode active material that comprises a first plurality of lithium iron phosphate particles having a first average particle size and a second plurality of lithium iron phosphate particles having a second average particle size; the cathode active material in contact with at least one of the current collectors;
wherein the cathode active material has a bimodal distribution of lithium iron phosphate particles.

2. The lithium ion battery of claim 1, wherein the first average particle size is about 3.5 μm.

3. The lithium ion battery of claim 1, wherein the second average particle size is about 0.7 μm.

4. The lithium ion battery of claim 1 further comprising a weight percentage of the first plurality of lithium iron phosphate particles in a range of 5 wt. % to 60 wt. % as a function of the total weight of lithium iron phosphate particles.

5. The lithium ion battery of claim 4, wherein the weight percentage of the first plurality of lithium iron phosphate particles is in a range of 10 wt. % to 45 wt. % as a function of the total weight of lithium iron phosphate particles.

6. The lithium ion battery of claim 5, wherein the weight percentage of the first plurality of lithium iron phosphate particles is in a range of 15 wt. % to 25 wt. % as a function of the total weight of lithium iron phosphate particles.

7. The lithium ion battery of claim 6, wherein the weight percentage of the first plurality of lithium iron phosphate particles is 20 wt. % as a function of the total weight of lithium iron phosphate particles.

8. The lithium ion battery of claim 1, wherein the cathode active material further comprises about 1 to 10 wt. % of a binder based on the total weight of the cathode active material.

9. The lithium ion battery of claim 1, wherein the cathode active material has a tap density greater than either a tap density of the first plurality of lithium iron phosphate particles or a tap density of the second plurality of lithium iron phosphate particles.

10. The lithium ion battery of claim 9, wherein the cathode active material has a tap density greater than both the tap density of the first plurality of lithium iron phosphate particles and the tap density of the second plurality of lithium iron phosphate particles.

11. A method of reducing the resistance in a cathode active material that includes a plurality of lithium iron phosphate particles, the method comprising:
providing a plurality of lithium iron phosphate particles having a first resistance;
admixing with the plurality of lithium iron phosphate particles having the first resistance a plurality of lithium iron phosphate particles having a second resistance that is greater than the first resistance, to form an admixture; and
wherein the resistance of the admixture is equal to or less than the first resistance.

12. The method of claim 11, wherein the plurality of lithium iron phosphate particles having the first resistance has an average particle size of about 0.7 μm; and the plurality of lithium iron phosphate particles having the second resistance has an average particle size of about 3.5 μm.

13. The method of claim 11, wherein admixing comprises
providing in the admixture a range of 5 wt. % to 60 wt. % of the of lithium iron phosphate particles having the second resistance, as a function of the total weight of lithium iron phosphate particles.

14. The method of claim 13, wherein admixing comprises
providing in the admixture a range of 10 wt. % to 45 wt. % of the of lithium iron phosphate particles having the second resistance, as a function of the total weight of lithium iron phosphate particles.

15. The method of claim 14, wherein admixing comprises
providing in the admixture a range of 15 wt. % to 25 wt. % of the of lithium iron phosphate particles having the second resistance, as a function of the total weight of lithium iron phosphate particles.

16. The method of claim 15, wherein admixing comprises
providing in the admixture 20 wt. % of the of lithium iron phosphate particles having the second resistance, as a function of the total weight of lithium iron phosphate particles.
